(19) United States
(12) Patent Application Publication
(10) Pub. No.: US 2007/0043725 A1
(43) Pub. Date: Feb. 22, 2007

(54) Feedback responsive input arrangements

(76) Inventors: Steve Hotelling, San Jose, CA (US); Scott Brenneman, Palo Alto, CA (US); Bart Andre, Menlo Park, CA (US); Chad Andrew Bronstein, San Francisco, CA (US); Brian Q. Huppi, San Francisco, CA (US); Chris Ligtenberg, San Carlos, CA (US); Eugene Whang, San Francisco, CA (US); Zachary Zeliff, San Jose, CA (US)

Correspondence Address: IPSG, P.C., P.O. BOX 700640, SAN JOSE, CA, 95170-0640, US

(21) Appl. No.: 11/204,873

(22) Filed: Aug. 16, 2005

(51) Int. Cl. G06F 17/30

(52) U.S. Cl. 707/9

(57) ABSTRACT

Feedback responsive input arrangements are presented where arrangements includes: a sensor in mechanical communication with a surface layer, the sensor configured to generate electronic signals in response to applied forces exerted upon the surface layer; a processing module configured to convert electronic signals into user-defined programmatic dimensions; and a tactile feedback response component configured to actuate in response to electronic signals. In some embodiments, user defined programmatic dimensions are selected from the group consisting of: a state dimension, a magnitude dimension, and a temporal dimension. In some embodiments, the processing module is further configured to process user-defined programmatic dimensions into user-defined programmatic actions. In some embodiments, user-defined programmatic actions are coupled to graphical environments, the graphical environments configured to provide a graphic feedback response based on user-defined programmatic actions. In some embodiments user-defined programmatic actions are coupled to an aural environment, the aural environment configured to provide an aural feedback.

### BACKGROUND OF THE INVENTION

Input and output (I/O) functions for computing systems continue to evolve as users develop increasingly more interactive applications. The mouse is perhaps one of the most well-known I/O devices currently in use. With a mouse, a user may move a cursor, select an object or group of objects, scroll a page, or utilize any number of functions well known in the art. Furthermore, a mouse may be configured for wired or wireless operation. Indeed, the mouse is an economical and useful tool for computer users.

Advances in pointer technology, however, have added additional benefits over the ubiquitous mouse. In some examples, trackpads have allowed users to eliminate the mouse altogether. Trackpads allow a user to move a cursor using only a finger or pointing stylus. Trackpads may also allow selection by lightly tapping the pad that effectively mimics a button on a mouse. Further advancements in trackpads include pads incorporating a level of feedback. Indeed, some trackpads are known in art which move slightly with a user's touch thus indicating to a user that an action has taken place.

At least one reason why feedback may be desirable is to enhance remote manipulation of computerized devices. For example, machine controlled manipulation of a surgical device typically requires precision movements to avoid injury to a patient. By utilizing a measure of feedback to a surgeon, the surgeon may be able to more effectively “feel” the instrument thus enhancing control of the instrument. In other examples, feedback may be desirable simply to enhance a user's computing experience. In gaming technology, for example, a player may “feel” a variety of sensations including movement, or a bump, or a vibration that corresponds to the gaming environment.

Despite advances in trackpad enhancement, other input devices lack feedback responsive functions. For example, a limited function feedback device may find utility in applications requiring specific function or that require simultaneous functionality with an enhanced trackpad. In those instances, a second trackpad may be cost prohibitive or may present obstacles to implementation in low profile devices. These devices may include tactile feedback responsive components as well as graphical feedback responsive components that may provide synergistic benefits to a user. Therefore, feedback responsive input arrangements are presented herein.

### SUMMARY OF INVENTION

Feedback responsive input arrangements are presented where arrangements includes: a sensor in mechanical communication with a surface layer, the sensor configured to generate electronic signals in response to applied forces exerted upon the surface layer; a processing module configured to convert electronic signals into user-defined programmatic dimensions; and a tactile feedback response component configured to actuate in response to electronic signals. In some embodiments, user defined programmatic dimensions are selected from the group consisting of: a state dimension, a magnitude dimension, and a temporal dimension. In some embodiments, the processing module is further configured to process user-defined programmatic dimensions into user-defined programmatic actions. In some embodiments, user-defined programmatic actions are coupled to graphical environments, the graphical environments configured to provide a graphic feedback response based on user-defined programmatic actions. In some embodiments user-defined programmatic actions are coupled to an aural environment, the aural environment configured to provide an aural feedback response based on user-defined programmatic actions.

In other embodiments, an array of feedback responsive input arrangements are presented including: an array of sensors in mechanical communication with an array of surface layers, the array of sensors configured to generate electronic signals in response to applied forces exerted upon the array of surface layers; a processing module configured to convert electronic signals into user-defined programmatic dimensions; and a tactile feedback response component configured to actuate in response to electronic signals. In some embodiments, user-defined programmatic dimensions are selected from the group consisting of: a state dimension, a magnitude dimension, and a temporal dimension. In some embodiments, the processing module is further configured to process user-defined programmatic dimensions into user-defined programmatic actions. In some embodiments, user-defined programmatic actions are coupled to a graphical environment, the graphical environment configured to provide a graphic feedback response based on user-defined programmatic actions. In some embodiments, user-defined programmatic actions are coupled to an aural environment, the aural environment configured to provide an aural feedback response based on user-defined programmatic actions.

In other embodiments, systems of controlling a feedback responsive input arrangement are presented including: an input module for receiving input forces; a processing module for converting input forces into user-defined programmatic actions; and an output module for providing user directed feedback in response to user-defined programmatic actions. In some embodiments, the input module includes sensors for receiving input forces, the sensors generating electronic signals. In some embodiments, the sensors are selected from the group consisting of: a force-sensing capacitor, a force-sensing resistor, a strain gauge, and a force-sensing piezo cell. In some embodiments, the processing module includes: conditioning circuitry for receiving electronic signals; a controller for converting electronic signals into user-defined programmatic actions; a driver configured to generate feedback response signals in response to user-defined programmatic actions; and a driver power source for delivering power in response to feedback response signals. In some embodiments, the output module includes: an actuator component for delivering tactile feedback responses based on feedback response signals, the actuator component receiving power from the driver power source; a graphical user interface for delivering graphical feedback responses based on user-defined programmatic actions; and an aural component for delivering aural feedback responses based on user-defined programmatic actions.

In other embodiments, methods for providing user responsive feedback are presented including: receiving user input; generating electronic signals based on the user input; generating user-defined programmatic dimensions based on electronic signals; and providing user responsive feedback based on user-defined programmatic dimensions. In some embodiments, methods further include conditioning electronic signals. In some embodiments, user-defined programmatic dimensions are selected from the group consisting of: a state dimension, a magnitude dimension, and a temporal dimension. In some embodiments, user responsive feedback is selected from the group consisting of: a tactile feedback response, a graphical feedback response, and an aural feedback response.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is an illustrative representation of a portable computing device in accordance with embodiments of the present invention;

FIGS. 2A-B are an illustrative representation of a cross-section of a capacitive feedback input arrangement and an illustrative graphical representation of a capacitance vs. force curve in accordance with embodiments of the present invention;

FIGS. 3A-B are an illustrative representation of a cross-section of a resistor feedback input arrangement and an illustrative graphical representation of a resistance vs. force curve in accordance with embodiments of the present invention;

FIGS. 4A-B are an illustrative representation of a cross-section of a piezo feedback input arrangement and an illustrative graphical representation of a voltage vs. strain curve in accordance with embodiments of the present invention;

FIGS. 5A-B are an illustrative representation of a cross-section of a strain gauge feedback input arrangement and an illustrative graphical representation of a resistance vs. force curve in accordance with embodiments of the present invention;

FIGS. 6A-B are illustrative representations of example actuators in accordance with embodiments of the present invention;

FIG. 7 is a diagrammatic representation of a control system in accordance with embodiments of the present invention; and

FIG. 8 is a flowchart of a method for providing user responsive feedback in an embodiment of the present invention.

### DETAILED DESCRIPTION OF EMBODIMENTS

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

Various embodiments are described hereinbelow, including methods and techniques. It should be kept in mind that the invention might also cover articles of manufacture that includes a computer readable medium on which computer-readable instructions for carrying out embodiments of the inventive technique are stored. The computer readable medium may include, for example, semiconductor, magnetic, opto-magnetic, optical, or other forms of computer readable medium for storing computer readable code. Further, the invention may also cover apparatuses for practicing embodiments of the invention. Such apparatus may include circuits, dedicated and/or programmable, to carry out tasks pertaining to embodiments of the invention. Examples of such apparatus include a general-purpose computer and/or a dedicated computing device when appropriately programmed and may include a combination of a computer/computing device and dedicated/programmable circuits adapted for the various tasks pertaining to embodiments of the invention.

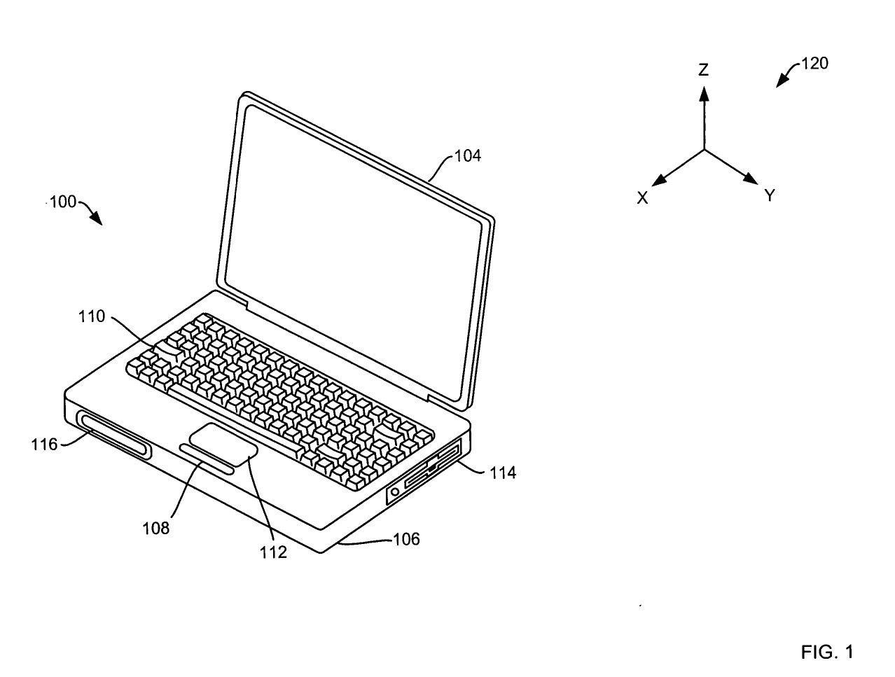

FIG. 1 is an illustrative representation of a portable computing device 100. As can be appreciated, some of the illustrations provided herein are shown in orthogonal view. A viewing axes 120 is provided for clarity in interpreting the figures and should not be considered limiting. Viewing axes 120 includes three axes of orientation namely: x-axis (i.e. forward and backward); y-axis (i.e. left and right); and z-axis (i.e. up and down).

Illustrated portable computing device 100 includes a base 106 and a display 104. Base 106 may house a variety of computer components including a keyboard 110, a pointing device 112, a selection device or button 108, a removable disk drive 114, and a permanent disk drive 116 in embodiments of the present invention. Base 106 may further include a variety of access ports for interfacing with other computing components including, but not limited to, a USB port (not shown), a parallel port (not shown), a serial port (not shown), a docking station interconnect (not shown), a network port (not shown) or a monitor port (not shown). Further, display 104 may be configured in any of a number of different sizes and resolutions depending on user preference.

As will be appreciated, embodiments of the present invention are particularly related to selection device or button 108. However, location and placement of selection device or button 108 may vary in accordance with user preferences. Indeed, selection device or button 108 may be co-located (i.e. above or below) with pointing device 112. Additionally, in some embodiments, a second selection device or button may be located along an edge of base 106. Thus, embodiments contemplated are various and illustrated selection device or button 108 should not be construed as limiting with regard to location or placement.

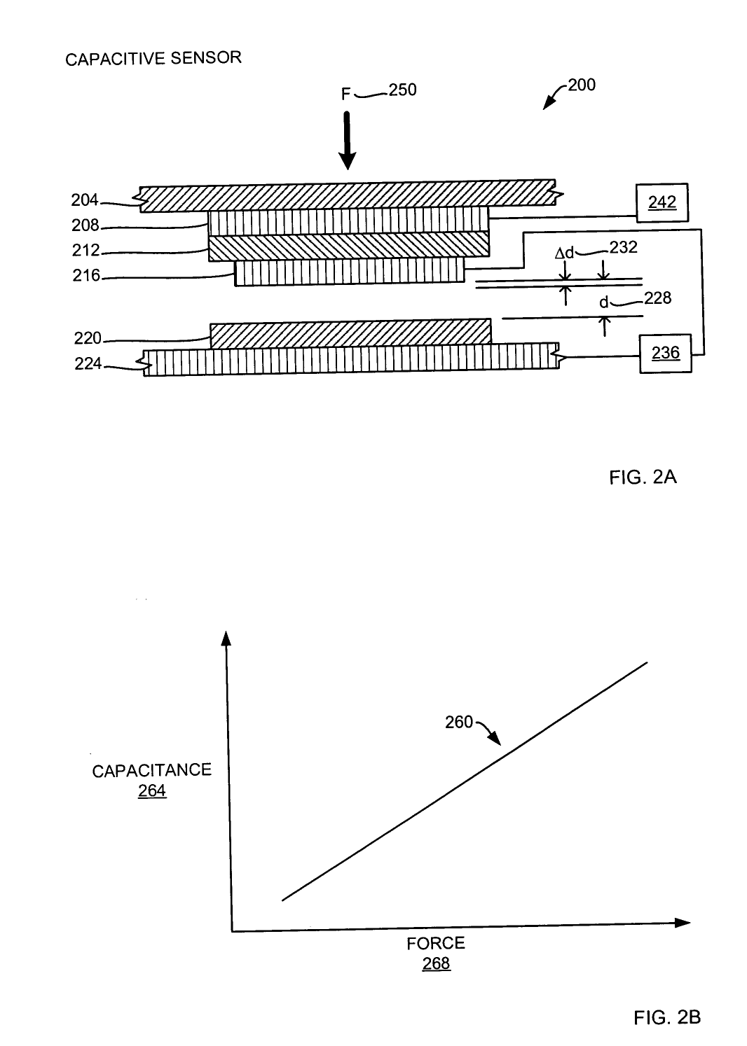

FIG. 2A is an illustrative representation of a cross-section of a capacitive feedback input arrangement 200 in embodiments of the present invention. As illustrated, capacitive feedback input arrangement 200 comprises several layers: surface layer 204; conductive shielding layer 208; insulator layer 212; conductive plate layer 216; insulator layer 220; and rigid conductive layer 224. For simplicity, adhesive layers are not shown. Adhesives are generally well-known in the art. One skilled in the art will readily recognize that any number of appropriate adhesives may be used without departing from the present invention. Furthermore, the use of hatching in this and other illustrations is for clarity only and should not be construed as having any other substantive property.

As can be appreciated, the capacitance between two substantially parallel layers is given by the following equation:
C=eA/d Equation 1:

Where A is the conductive plate layer area (e.g. conductive plate layer 208), d is the distance between the layers (e.g. Air gap 228), and e is the permittivity of the dielectric medium (e.g. Air gap 228). Capacitive sensor 200 relies on applied force 250 either changing the distance between the layers (e.g. Δd distance 232) or, in some examples, the effective surface area of the capacitor. Thus, in capacitive sensor 200 two conductive layers 216, 224 are separated by an air gap 228 (i.e. dielectric medium) to give the sensor its force-to-capacitance characteristics. Sensing circuitry 236 detects or measure change in capacitance and may be coupled with conditioning circuitry in some embodiments. Further, embodiments of the present invention may include a conductive shielding layer 208. Conductive shielding layer 208 serves to prevent stray capacitance changes caused by approach of a user's finger or pointing stylus. Conductive shielding layer 208 is typically be grounded or otherwise tied to a fixed voltage 242.

In some embodiments, rigid layer 224 may be a conductive plate while in other embodiments a conductive layer may be attached with rigid plate 224. Finally, surface layer 204 may be composed of any non-conductive elastomeric compound. Elastomeric compounds may be selected in accordance with user preferences. For example, where hazardous substances may come in contact with surface layer 204, a chemically resistant elastomeric compound may be used. Further, elastomeric compounds may be selected in accordance with rigidity specifications. Thus, a more rigid elastomeric compound may be used in embodiments where a user desires to reduce false positive contacts. The reverse may apply equally as well. That is, a less rigid elastomeric compound may be used in embodiments to reduce false negative contacts.

FIG. 2B is an illustrative graphical representation of a capacitance vs. force curve in embodiments of the present invention. As can be appreciated, a mathematical relationship exists between the force 250 exerted against surface layer 204 (see FIG. 2A). The curve 260 illustrates capacitance 264 as a function of force 268. Thus, capacitance increases as force increases (i.e. as the distance between the conductive plates diminishes). One skilled in the art will recognize that curve 260 is for illustrative purposes only and therefore only demonstrates a general trend. Curve 260 is not intended to indicate a strictly linear relationship between capacitance and force and should not be construed as limiting in that respect.

Because of the mathematical relationship between force and capacitance, sensor 200 may be utilized to produce several dimensions. A first dimension is a state dimension. That is, whether capacitance has changed from some threshold value or not. Thus, a sensor at rest may produce a zero state capacitance (C₀). When force is applied to the sensor, capacitance may enter a one state capacitance (C₁). That is, the sensor is either at rest or not at rest as indicated by state. This dimension may be desirable where an on or off state is desired or where a switch emulation is desired. A second dimension is a magnitude dimension. A magnitude dimension may be calculated because capacitance changes in response to force. This dimension may be desirable where a determination of an amount of force applied to a selection device or button is desirable or in applications that may utilize a magnitude dimension such as in a volume control application for example.

A third dimension is a temporal dimension. This dimension may be calculated based at least in part upon a state dimension. Thus, when a selection device or button is activated from a zero state (C₀), a timer may be initiated. When the selection device or button is released to a zero state (C₀), a timer may be stopped. Thus, an activation duration interval may be calculated corresponding to the interval in which a user has maintained contact with a selection device or button. This dimension may be useful in applications where a temporal element is desired. Thus, for example, in training simulations, a critical time interval for a given process may be tracked using this functionality. As can be appreciated, the three dimensions: state dimension, magnitude dimension, and temporal dimension may find utility in many applications without departing from the present invention.

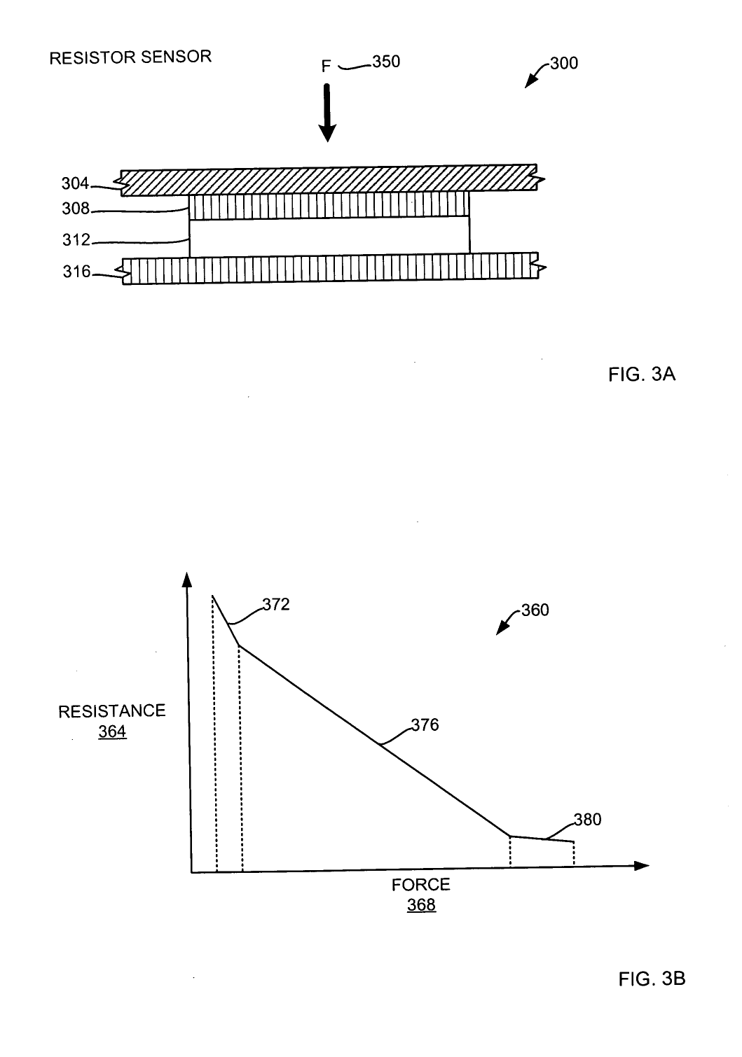

FIG. 3A is an illustrative representation of a cross-section of a resistor feedback input arrangement 300 in accordance with embodiments of the present invention. As illustrated, resistor feedback input arrangement 300 comprises several layers: surface layer 304; foam layer 308; force-sensing resistor layer 312; and rigid layer 316. For simplicity, adhesive layers are not shown. Adhesives are generally well-known in the art. One skilled in the art will readily recognize that any number of appropriate adhesives may be used without departing from the present invention. Furthermore, the use of hatching in this and other illustrations is for clarity only and should not be construed as having any other substantive property.

As their name implies, force sensing resistors use the electrical property of resistance to measure a force applied to a sensor. In general, force sensing resistors may be composed of a polymeric layer (e.g. force-sensing resistor layer 312) which exhibits a decrease in resistance with an increase in force 350 applied to the active surface. A force sensing resistor generally includes at least two components. The first component is a resistive material applied to a first film. The second is a set of digitating contacts applied to a second film. The resistive material serves to make an electrical path between the two sets of conductors on the second film. When a force is applied to this sensor, a better connection is made between the contacts, hence the conductivity is increased (i.e. resistance is decreased). Over a wide range of forces, conductivity is approximately a linear function of force (i.e. FαC, Fα1/R).

Typically, when low forces are applied to force sensing resistors, a switch-like response may be exhibited. This threshold may be controlled by the top substrate material (e.g. surface layer 304) and overlay (e.g. foam layer 308) thickness and flexibility. This behavior may be useful when designing switches. When high forces are applied to force sensing resistors, responses may be substantially linear until saturation is reached whereupon increases in forces applied to force sensing resistors yield little or no decrease in resistance.

FIG. 3B is an illustrative graphical representation of a resistance vs. force curve 360 in accordance with embodiments of the present invention. As can be appreciated, a mathematical relationship exists between force 350 exerted against surface layer 304. Curve 360 illustrates resistance 364 as a function of force 368. Thus, as force increases, resistance decreases. Further, curve 360 illustrates typical behavior of force sensing resistors as noted above. That is, switch-like change is exhibited at section 372 where low forces are applied; linear change is exhibited at section 376; and saturation is exhibited at section 380. One skilled in the art will recognize that curve 360 is for illustrative purposes only and therefore only demonstrates a general trend. Curve 360 is not intended to indicate a strictly linear relationship between capacitance and force and should not be construed as limiting in that respect.

As noted above, because of the mathematical relationship between force and resistance, sensor 300 may be utilized to produce several dimensions. A first dimension is a state dimension. That is, whether resistance has changed from some threshold value or not. Thus, a sensor at rest may produce a zero state resistance (R₀). When force is applied to the sensor, resistance may enter a one state resistance (R₁). That is, the sensor is either at rest or not at rest as indicated by state. This dimension may be desirable where an on or off state is desired or where a switch emulation is desired. A second dimension is a magnitude dimension. A magnitude dimension may be calculated because resistance changes in response to force. This dimension may be desirable where a determination of an amount of force applied to a selection device or button is desirable or in applications that may utilize a magnitude dimension such as in a volume control application for example.

A third dimension is a temporal dimension. This dimension may be calculated based at least in part upon a state dimension. Thus, when a selection device or button is activated from a zero state (R₀), a timer may be initiated. When the selection device or button is released to a zero state (R₀), a timer may be stopped. Thus, an activation duration interval may be calculated corresponding to the interval in which a user has maintained contact with a selection device or button. This dimension may be useful in applications where a temporal element is desired. Thus, for example, in training simulations, a critical time interval for a given process may be tracked using this functionality. As can be appreciated, the three dimensions: state dimension, magnitude dimension, and temporal dimension may find utility in many applications without departing from the present invention.

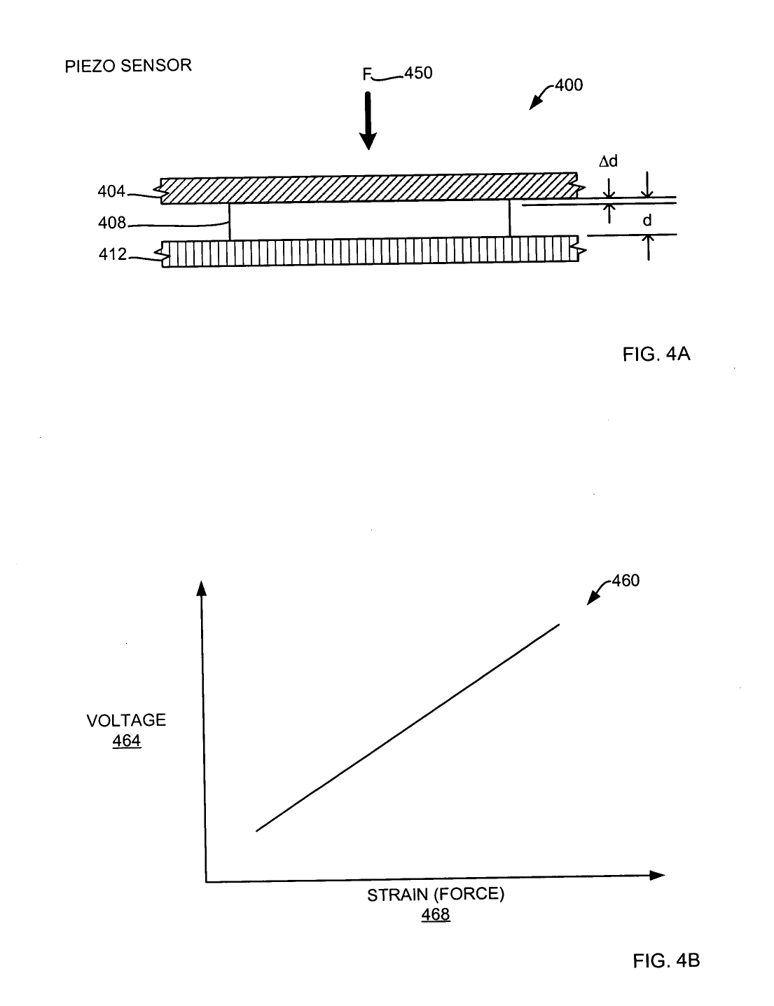

FIG. 4A is an illustrative representation of a cross-section of a piezo feedback input arrangement 400 in accordance with embodiments of the present invention. As illustrated, resistor feedback input arrangement 400 comprises several layers: surface layer 404; piezo layer 408; and rigid layer 412. For simplicity, adhesive layers are not shown. Adhesives are generally well-known in the art. One skilled in the art will readily recognize that any number of appropriate adhesives may be used without departing from the present invention. Furthermore, the use of hatching in this and other illustrations is for clarity only and should not be construed as having any other substantive property.

Piezo sensors are generally well known in the art. When a mechanical stress (e.g. Force 450) is applied to a piezo element in a longitudinal direction (i.e. parallel to polarization), a voltage is generated. In general, as force 450 increases, voltage also increases. As a sensor, piezo elements are generally utilized in applications requiring dynamic or transient inputs. Piezo elements are not generally selected for static input because of charge leakages between electrodes and monitoring circuit. Piezo elements generally exhibit high signal/noise ratios that exceed most strain gauges, yet may remain small in size for space confined applications.

FIG. 4B is an illustrative graphical representation of a voltage 464 vs. strain 468 curve 460 in accordance with embodiments of the present invention. As illustrated, voltage 464 increases as force 468 increases. One skilled in the art will recognize that curve 460 is for illustrative purposes only and therefore only demonstrates a general trend. Curve 460 is not intended to indicate a strictly linear relationship between voltage and force and should not be construed as limiting in that respect.

As noted above, because of the mathematical relationship between force and voltage, sensor 400 may be utilized to produce several dimensions. A first dimension is a state dimension. That is, whether voltage has changed from some threshold value or not. Thus, a sensor at rest may produce a zero state voltage (V₀). When force is applied to the sensor, voltage may enter a one state voltage (V₁). That is, the sensor is either at rest or not at rest as indicated by state. This dimension may be desirable where an on or off state is desired or where a switch emulation is desired. A second dimension is a magnitude dimension. A magnitude dimension may be calculated because voltage changes in response to force. This dimension may be desirable where a determination of an amount of force applied to a selection device or button is desirable or in applications that may utilize a magnitude dimension such as in a volume control application for example.

A third dimension is a temporal dimension. This dimension may be calculated based at least in part upon a state dimension. Thus, when a selection device or button is activated from a zero state (V₀), a timer may be initiated. When the selection device or button is released to a zero state (V₀), a timer may be stopped. Thus, an activation duration interval may be calculated corresponding to the interval in which a user has maintained contact with a selection device or button. This dimension may be useful in applications where a temporal element is desired. Thus, for example, in training simulations, a critical time interval for a given process may be tracked using this functionality. As can be appreciated, the three dimensions: state dimension, magnitude dimension, and temporal dimension may find utility in many applications without departing from the present invention.

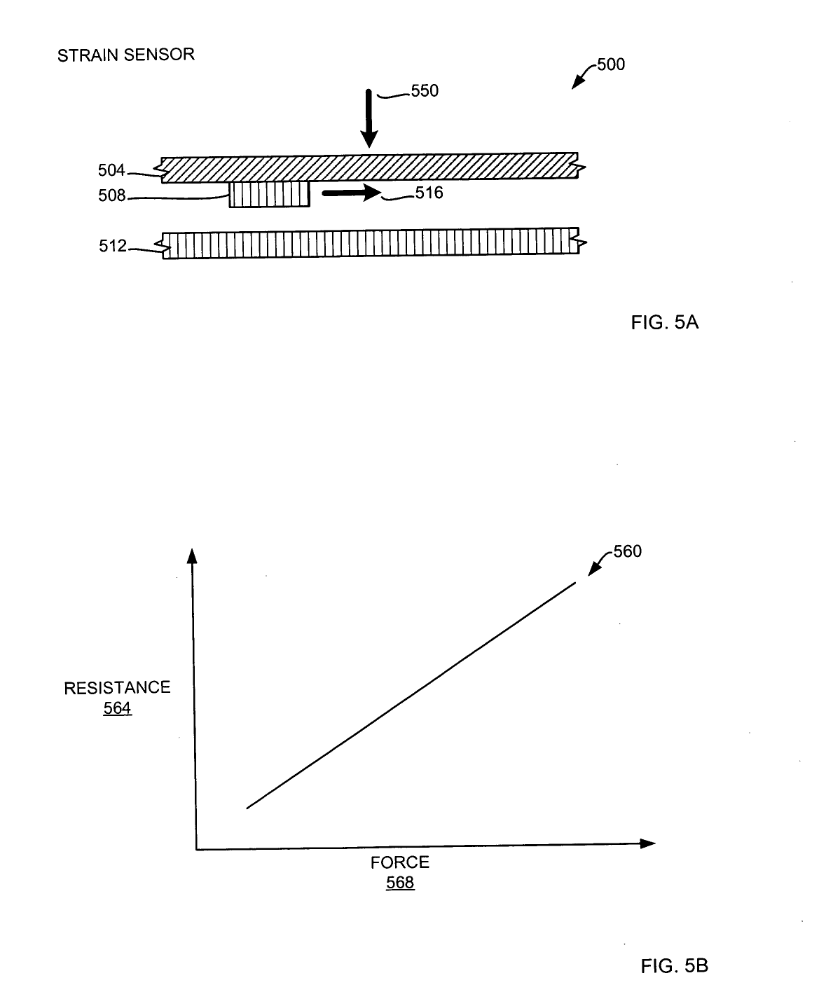

FIG. 5A is an illustrative representation of a cross-section of a strain gauge feedback input arrangement in accordance with embodiments of the present invention. As illustrated, strain gauge feedback input arrangement 500 comprises several layers: surface layer 504; strain gauge sensor layer 508; and rigid layer 512. For simplicity, adhesive layers are not shown. Adhesives are generally well-known in the art. One skilled in the art will readily recognize that any number of appropriate adhesives may be used without departing from the present invention. Furthermore, the use of hatching in this and other illustrations is for clarity only and should not be construed as having any other substantive property.

A strain gauge is a device whose electrical resistance varies in proportion to the amount of strain in the device. A commonly used strain gauge is a bonded metallic strain gauge. A bonded metallic strain gauge consists of a very fine wire; metallic foil arranged in a grid pattern; or conductive ink printed on a flexible substrate. The grid pattern maximizes the amount of metallic wire or foil subject to strain in the parallel direction. It is very important that the strain gauge be properly mounted onto a surface layer so that the strain is accurately transferred from the surface layer, through the adhesive, through the strain gauge backing, and to the metallic foil itself. In this manner, strain experienced by the surface layer may be transferred directly to the strain gauge, which responds with a substantially linear change in electrical resistance. The change in resistance is generally small and so typically requires a reference resistance and compensating circuitry to compensate for other sources of resistance changes (such as temperature). So, for example, when force 550 is applied to surface layer 504, strain gauge sensor layer 508 is deformed as indicated by arrow 516 resulting in stress and strain. Stress is defined as an object's internal resisting forces, and strain is defined as the displacement and deformation that occur. Strain gauges are generally available commercially.

FIG. 5B is an illustrative graphical representation of a resistance 564 vs. force 568 curve 560 in accordance with embodiments of the present invention. As noted above, a strain gauge's resistance changes as function of force as illustrated by curve 560. One skilled in the art will recognize that curve 560 is for illustrative purposes only and therefore only demonstrates a general trend. Curve 560 is not intended to indicate a strictly linear relationship between resistance and force and should not be construed as limiting in that respect. Furthermore, some embodiments may be configured such that resistance decreases in response to increases in force depending on user preferences.

As noted above, because of the mathematical relationship between force and resistance, sensor 500 may be utilized to produce several dimensions. A first dimension is a state dimension. That is, whether resistance has changed from some threshold value or not. Thus, a sensor at rest may produce a zero state resistance (R₀). When force is applied to the sensor, resistance may enter a one state resistance (R₁). That is, the sensor is either at rest or not at rest as indicated by state. This dimension may be desirable where an on or off state is desired or where a switch emulation is desired. A second dimension is a magnitude dimension. A magnitude dimension may be calculated because resistance changes in response to force. This dimension may be desirable where a determination of an amount of force applied to a selection device or button is desirable or in applications that may utilize a magnitude dimension such as in a volume control application for example.

A third dimension is a temporal dimension. This dimension may be calculated based at least in part upon a state dimension. Thus, when a selection device or button is activated from a zero state (R₀), a timer may be initiated. When the selection device or button is released to a zero state (R₀), a timer may be stopped. Thus, an activation duration interval may be calculated corresponding to the interval in which a user has maintained contact with a selection device or button. This dimension may be useful in applications where a temporal element is desired. Thus, for example, in training simulations, a critical time interval for a given process may be tracked using this functionality. As can be appreciated, the three dimensions: state dimension, magnitude dimension, and temporal dimension may find utility in many applications without departing from the present invention.

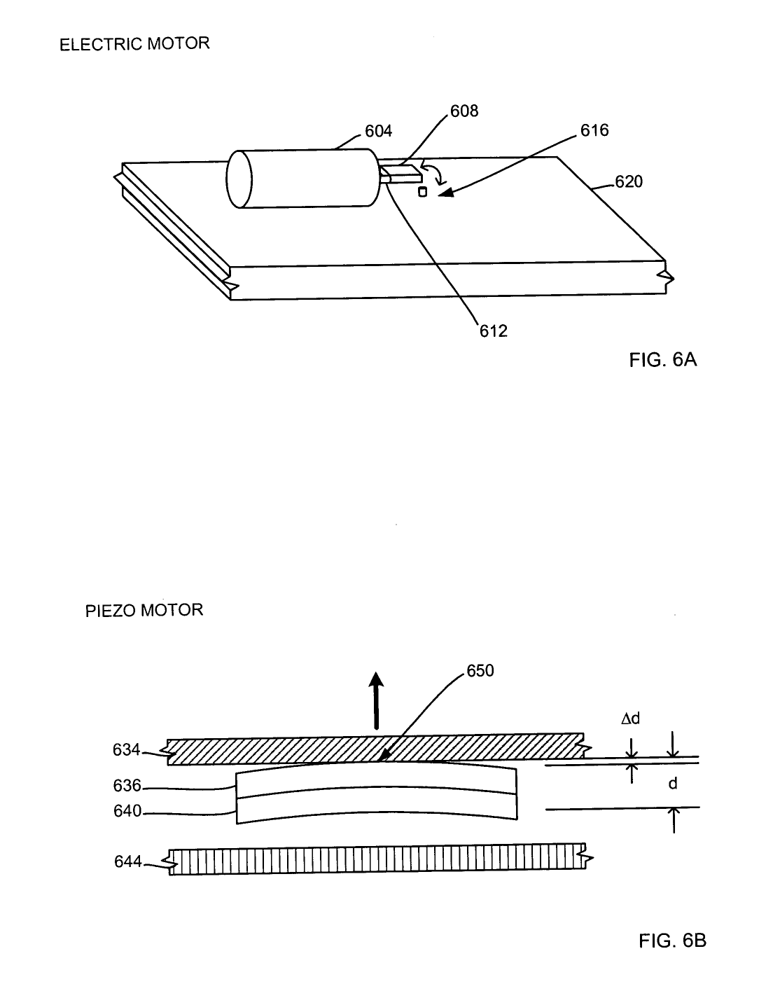

FIGS. 6A-B are illustrative representations of example actuators in accordance with embodiments of the present invention. As noted above, tactile feedback responsive components may provide additional user benefits by allowing a user to “feel” a selection. This is particularly true where selections are made with a device having motionless or near motionless surface as in those embodiments describe above. In those examples, lack of tactile feedback may result in a user inadvertently repeating a selection resulting in false selections. Thus, some form of feedback may be desirable. FIG. 6A illustrates a simple motor 604 having an eccentric weight 608 attached with motor 604 by a rotating axle 612. When a selection is made, motor 604 may be configured to swing eccentric weight 608 thus striking surface 620. In some embodiments, motor 604 swings eccentric weight 608 to strike raised feature 616. When eccentric weight strikes surface 620 or raised feature 616, a shockwave is transmitted through surface 620. A user may sense this shockwave through a finger or pointing stylus.

In some embodiments, eccentric weight 608 may then be returned to its original position immediately or may simply await a next actuation whereupon eccentric weight will rotate in the opposite direction to strike surface 620. As noted above, a magnitude dimension may be calculated in some embodiments. Thus, motor 604 may be configured to respond to a magnitude dimension such that as magnitude is increased, motor speed may also be increased to reflect the magnitude. In other words, a user may receive tactile response at a level corresponding to the force with which the user uses to make a selection. As can be appreciated, surface materials may be selected in accordance with user preferences. Thus, a rigid surface material may be utilized to distribute a shockwave. In the same manner, a more pliable surface may be utilized to absorb a shockwave.

FIG. 6B illustrates a piezo motor 630 in accordance with embodiments of the present invention. As illustrated a two-layer piezo element 636/640 may bend thus generating an impact 650 with surface layer 634. Two-layer piezo elements 636/640 may be attached with surface layer 634 or with rigid layer 644 in any manner known in the art. Two-layer piezo elements can be made to elongate, bend, or twist depending on the polarization and wiring configuration of the layers. A center shim laminated between the two piezo layers adds mechanical strength and stiffness, but reduces motion. “Two-layer” refers to the number of piezo layers. The “Two-layer” element actually has nine layers, consisting of: four electrode layers, two piezoceramic layers, two adhesive layers, and a center shim not shown. A two-layer piezo element produces curvature when one layer expands while the other layer contracts. Bender motion on the order of hundreds to thousands of microns, and bender force from tens to hundreds of grams, is typical. As can be appreciated by one skilled in the art, any number of piezo layers may be stacked on top of one another. Increasing volume of piezo elements increases the energy that may delivered to a surface. Piezo motors are generally well-known in the art and are generally commercially available.

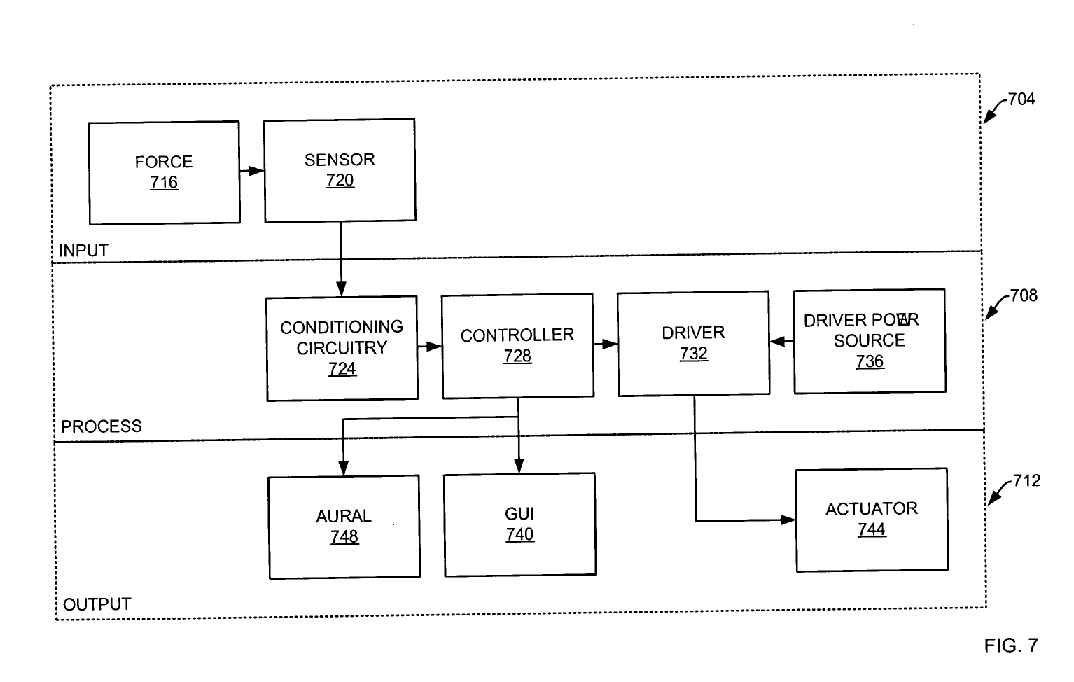

FIG. 7 is a diagrammatic representation of a control system in accordance with embodiments of the present invention. A typical control system for use with embodiments described herein include input module 704, process module 708, and output module 712. Input module 704 includes force block 716 and sensor block 720. As noted above, input may come from a variety of sources including a finger or pointing stylus for example. Input force may be defined as a force exerted upon a surface area. As discussed above input force may generate a number of dimensions including a state dimension, a magnitude dimension, and a temporal dimension. Sensor block 720 may be configured to receive force 716 in any number of manners including those described above. Sensors may be selected in accordance with design requirements and user preferences.

Process module 708 includes conditioning circuitry block 724, controller block 728, driver block 732, and driver power source block 736. One purpose of conditioning circuitry block 724 is to convert energy from sensor block 720 into a usable and reliable form. For example, piezo elements typically generate very low voltages in response to deformation as noted above. Thus, conditioning circuitry may be utilized to create voltages in a usable range that correspond to low voltages produced. Further, conditioning circuitry 724 may account for external factor that might affect sensor readings such as temperature. Thus, for example, strain gauges, which are generally sensitive to temperature perturbations, may function properly with appropriate conditioning circuitry. Conditioning circuitry block 724 is electronically coupled with controller block 728. Controller block 728 processes signal from circuitry block 724 to effect some type of user output. For example, controller block 728 may receive a magnitude dimension from conditioning circuitry block 724 and then instruct driver block 732 generate a tactile feedback response. Driver block 732 may further optionally use driver power source 736 to implement actuator block 744. Driver power sources are generally well known in the art. Methods of actuation are described in further detail above and include, for example, a motor with eccentric weight, a piezo electric motor, a solenoid, a voice coil actuator, a hydraulic cylinder, and a pneumatic actuator.

In other examples controller block 728 may output instructions to GUI block 740 to generate a graphical feedback response. Graphical feedback responses may benefit a user by providing a visual context in which feedback may be useful. For example, a temporal dimension processed by controller block 728 may generate a visual timer for a user ease of use. In still other embodiments, controller block 728 may output instructions to aural block 748 to generate an aural feedback response. Aural feedback responses may benefit a visually impaired user or may be useful in environments where a sonic response would be more advantageous to a user.

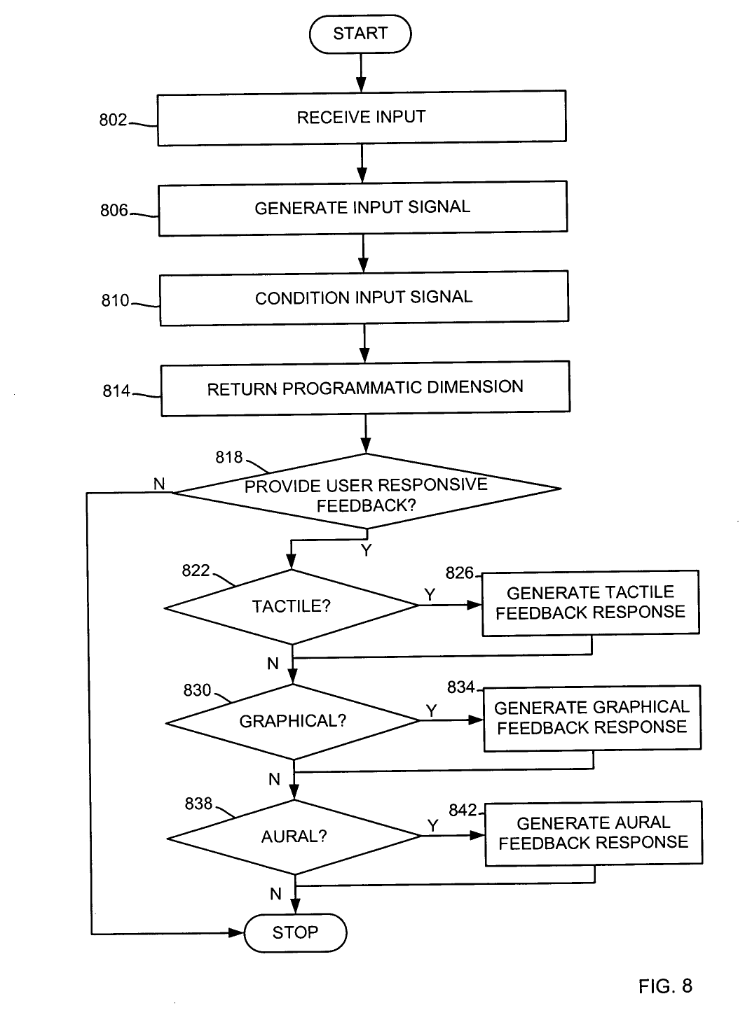

FIG. 8 is a flowchart of a method for providing user responsive feedback in an embodiment of the present invention. In particular, at a first step 802, the method receives input. As noted above, input may take the form of a force directed toward a sensor using either a finger or a pointing stylus. Input may be provided by any other method known in the art and may include, for example, a remotely controlled stylus. At a next step 806, the method generates an input signal. As noted above, a force exerted upon a sensor may generate an electronic signal. In embodiments of the present invention, a force and corresponding generated electronic signal may be mathematically related. This mathematical relationship provides a basis for defined programmatic dimensions as will be described at a step 814 below.

As can be appreciated in the art, electronic signals generated by sensors described herein may require conditioning due to noise (i.e. EMF), or other factors such as temperature which tend to adversely affect signal integrity. Thus, at a step 810, the method conditions an input signal. Conditioning may be accomplished by any method known in the art. Once a signal is conditions, a programmatic dimension may be returned at a step 814. A programmatic dimension is a dimension derived from a mathematical relationship between a force exerted on a sensor, and an electronic signal generated by that sensor, for example, a state dimension, a magnitude dimension, and a temporal dimension. Those dimensions are discussed in further detail above.

Once a programmatic dimension has been returned, the method determines whether to provide user responsive feedback at a step 818. If no user responsive feedback is desired, the method ends. If user responsive feedback is desired, the method determines whether tactile feedback is desired at a step 822. Tactile feedback is discussed in further detail above. In short, tactile feedback is feedback a user can “feel.” If tactile feedback is desired, then it is generated at a step 826 whereupon the method continues to determine whether graphical feedback is desired at a step 830. Graphical feedback is discussed in further detail above. In essence, graphical feedback is feedback that a user can see as, for example, on a computer screen. However, other methods of graphical feedback may be incorporated without departing from the present invention. If graphical feedback is desired, then it is generated at a step 834 whereon the method continues to determine whether aural feedback is desired at a step 838. Aural feedback is discussed in further detail above. Briefly, aural feedback is feedback that a user can hear. Thus, for example, a beep, or ring, or any other sound may be utilized to provide user feedback. If aural feedback is desired, then it is generated at a step 842 whereupon the method ends.

While this invention has been described in terms of several embodiments, there are alterations, permutations, and equivalents, which fall within the scope of this invention. It should also be noted that there are many alternative ways of implementing the methods and apparatuses of the present invention. It is therefore intended that the following appended claims be interpreted as including all such alterations, permutations, and equivalents as fall within the true spirit and scope of the present invention.

What is claimed is:

1. A feedback responsive input arrangement comprising:
a sensor in mechanical communication with a surface layer, the sensor configured to generate a first electronic signal in response to an applied force exerted upon the surface layer;
a processing module configured to convert the first electronic signal into at least one user-defined programmatic dimension; and
a tactile feedback response component configured to actuate in response to the first electronic signal.

2. The arrangement of claim 1 wherein the at least one user defined programmatic dimension is selected from the group consisting of: a state dimension, a magnitude dimension, and a temporal dimension.

3. The arrangement of claim 1 wherein the processing module is further configured to process the at least one user-defined programmatic dimension into at least one user-defined programmatic action.

4. The arrangement of claim 3 wherein the at least one user-defined programmatic action is coupled to a graphical environment, the graphical environment configured to provide a graphic feedback response based on the at least one user-defined programmatic action.

5. The arrangement of claim 3 wherein the at least one user-defined programmatic action is coupled to an aural environment, the aural environment configured to provide an aural feedback response based on the at least one user-defined programmatic action

6. The arrangement of claim 3 wherein the at least one user-defined programmatic action is selected from the group consisting of: a selection, a de-selection, a hold, a magnitude registration, a start, and a stop.

7. The arrangement of claim 1 wherein the sensor is selected from the group consisting of: a force-sensing capacitor, a force-sensing resistor, a strain gauge, and a force-sensing piezo cell.

8. The arrangement of claim 1 wherein the tactile feedback response component is selected from the group consisting of: a motor with eccentric weight, a piezo electric motor, a solenoid, a voice coil actuator, a hydraulic cylinder, and a pneumatic actuator.

9. The arrangement of claim 8 wherein the motor with eccentric weight further comprises a surface feature configured to receive an impact generated by the motor.

10. An array of feedback responsive input arrangements comprising:
an array of sensors in mechanical communication with an array of surface layers, the array of sensors configured to generate a plurality electronic signals in response to a plurality of applied forces exerted upon the array of surface layers;
a processing module configured to convert the plurality electronic signals into at least one user-defined programmatic dimension; and
a tactile feedback response component configured to actuate in response to the plurality electronic signals.

11. The arrangement of claim 10 wherein the at least one user-defined programmatic dimension is selected from the group consisting of: a state dimension, a magnitude dimension, and a temporal dimension.

12. The arrangement of claim 10 wherein the processing module is further configured to process the at least one user-defined programmatic dimension into at least one user-defined programmatic action.

13. The arrangement of claim 12 wherein the at least one user-defined programmatic action is coupled to a graphical environment, the graphical environment configured to provide a graphic feedback response based on the at least one user-defined programmatic action.

14. The arrangement of claim 12 wherein the at least one user-defined programmatic action is coupled to an aural environment, the aural environment configured to provide an aural feedback response based on the at least one user-defined programmatic action

15. A system of controlling a feedback responsive input arrangement comprising:
an input module for receiving an input force;
a processing module for converting the input force into at least one user-defined programmatic action; and
an output module for providing user directed feedback in response to the at least one user-defined programmatic action.

16. The system of claim 15 wherein the input module comprises:
a sensor for receiving the input force, the sensor generating a first electronic signal.

17. The system of claim 16 wherein the sensor is selected from the group consisting of: a force-sensing capacitor, a force-sensing resistor, a strain gauge, and a force-sensing piezo cell.

18. The system of claim 15 wherein the processing module comprises:
conditioning circuitry for receiving the first electronic signal;
a controller for converting the first electronic signal into at least one user-defined programmatic action;
a driver configured to generate a feedback response signal in response to the at least one user-defined programmatic action; and
a driver power source for delivering power in response to the feedback response signal.

19. The system of claim 18 wherein the output module comprises:
an actuator component for delivering a tactile feedback response based on the feedback response signal, the actuator component receiving power from the driver power source;
a graphical user interface for delivering a graphical feedback response based on the at least one user-defined programmatic action; and
an aural component for delivering an aural feedback response based on the at least one user-defined programmatic action.

20. The system of claim 19 wherein the actuator component is selected from the group consisting of: a motor with eccentric weight, a piezo electric motor, a solenoid, a voice coil actuator, a hydraulic cylinder, and a pneumatic actuator.

21. A method for providing user responsive feedback comprising:
receiving a user input;
generating a first electronic signal based on the user input;
generating at least one user-defined programmatic dimension based on the first electronic signal; and
providing user responsive feedback based on the at least one user-defined programmatic dimension.

22. The method of claim 21 further comprising:
conditioning the first electronic signal.

23. The method of claim 21 wherein the at least one user-defined programmatic dimension is selected from the group consisting of: a state dimension, a magnitude dimension, and a temporal dimension.

24. The method of claim 21 wherein the user responsive feedback is selected from the group consisting of: a tactile feedback response, a graphical feedback response, and an aural feedback response.
